(19) United States
(12) Patent Application Publication
(10) Pub. No.: US 2012/0056475 A1
(43) Pub. Date: Mar. 8, 2012

(54) Vehicle-Used Power Supply System

(75) Inventors: Jung-Tzung Wei, Taoyuan County (TW); Chung-You Lin, Taoyuan County (TW); Kun-Huai Jheng, Taoyuan County (TW); Rou-Yong Duan, Taoyuan County (TW); Kuo-Kuang Jen, Taipei County (TW); Yu-Min Liao, Taoyuan County (TW)

(73) Assignee: Chung-Shan Institute of Science and Technology Armanments, Bureau, Ministry of National Defense, Taoyuan County (TW)

(21) Appl. No.: 12/968,157

(22) Filed: Dec. 14, 2010

(30) Foreign Application Priority Data
Sep. 3, 2010 (TW) 099129891

(51) Int. Cl. B60L 1/00

(52) U.S. Cl. 307/9.1

(57) ABSTRACT

Disclosed is a vehicle-used power supply system. The vehicle power supply system comprises a storage unit, a bidirectional dc/dc convertor, a dc bus, a controller and a driving module. The bidirectional dc/dc convertor is configured to boost the power stored in the storage unit to a dc bus power. The controller is configured to control the bidirectional dc/dc convertor to operate in a boost mode for driving the motor or in a buck mode for charging the storage unit. The driving module is configured to receive the dc bus power and drive the motor.

### BACKGROUND OF INVENTION

1. Field of Invention

The present invention relates to a vehicle and, more particularly, to a power supply system for use in a vehicle.

2. Related Prior Art

In view of the production of the fossil fuel is getting less and less and the problems related to the green house effect are getting worse and worse, it is getting more and more important to develop and use clean energy. Devices for using clean energy sources include fuel cells, photovoltaic devices and wind mills for example.

To use clean energy, there have been various hybrid vehicles each including an engine and a power supply system to reduce the exhaust of carbon dioxide considerably. Such a power supply system generally includes a rechargeable secondary battery module to effectively reduce the reserve of the clean energy to reduce the cost of buying and operating the power supply system. In practice, a hybrid model vehicle frequently and quickly uses the secondary battery module in cooperation with the engine to achieve an optimal efficiency of the fossil fuel. Hence, a high performance bi-directional power converter is a necessary power regulating device.

Generally, batteries are connected to one another in series to expand the capacity. The difference between the total voltage of the batteries and an electric device is reduced to avoid drawbacks entailed by a high boost ratio and a low conversion efficiency. The serial connection of the batteries to one another however details various problems. The most serious problem is that the life of the power supply system is short because it is determined by the shortest life of the batteries, i.e., the power supply system fails when any of the batteries fails. On the other hand, in consideration of the balance of the capacities of the secondary batteries, all of them must be replaced with new secondary batteries that would better be made by a same manufacturer so that the new secondary batteries can be matched. Therefore, the cost of the operation of the power supply system is high.

The foregoing problem can be solved by using batteries that are connected to one another in parallel for example. Moreover, the number of the batteries connected to one another in parallel can be increased or reduced arbitrarily. Hence, alleviated are the problems related to the maintenance of the hybrid vehicle and the management of the batteries. Accordingly, a low voltage power supply system and a bi-directional power converter with a high differential voltage ratio are important.

Most bi-directional power converters exist in the form of a transformer including power semiconductor switches and are therefore expensive. Moreover, there is loss in conversion and conduction as a current travels through a lot of switches. In addition, a transformer is not suitable for a voltage that changes in a large range because a variable excitation current saturates an iron core. The iron core must be large because the transformer bears all of the power.

The present invention is therefore intended to obviate or at least alleviate the problems encountered in prior art.

### SUMMARY OF INVENTION

It is the primary objective of the present invention to provide a power supply system operated with high conversion efficiency.

To achieve the foregoing objective, the power supply system includes an energy storage unit, a direct current bus, a bi-directional power converter, a controller and a drive module. The bi-directional power converter is electrically connected to the energy storage unit and the direct current bus. The controller is electrically connected to a motor and the bi-directional power converter. The drive module is electrically connected to the direct current bus, the controller and the motor.

The bi-directional power converter is a highly efficient power converter operated with a high boost and reduction ratio. The bi-directional power converter may include a coupling inductor. The coupling inductor may be a high excitation current double-winding transformer with a high air gap. The bi-directional power converter boosts electricity from the energy storage unit and provides direct current bus electricity for the drive module to drive the motor. In a braked mode, the drive module converts a counter electromotive force of the motor to the direct bus electricity and conducts the same to the bi-directional power converter which reduces the direct current bus electricity and recharges the energy storage unit.

The controller provides a first control signal and a second control signal based on the operation of the motor and the output of the electricity from the energy storage unit. The first control signal controls the bi-directional power converter to switch between a boost mode and a reduction mode.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is a block diagram of a vehicle-used power supply system according to the preferred embodiment of the present invention;

FIG. 2 is a block diagram of a bi-directional power converter used in the vehicle-used power supply system shown in FIG. 1;

FIG. 3 is an equivalent circuit diagram of the bi-directional power converter shown in FIG. 2;

FIG. 4 is an equivalent circuit diagram of the bi-directional power converter shown in FIG. 2 when it is recharged;

FIG. 5 is an equivalent circuit diagram of the bi-directional power converter shown in FIG. 2 when it discharges;

FIG. 6 is a chart of voltage and current versus time of the bi-directional power converter shown in FIG. 2 when it is recharged;

FIGS. 7A-7F shows various modes of the operation of the bi-directional power converter shown in FIG. 2 when it is recharged;

FIG. 8 is a chart of voltage and current versus time of the bi-directional power converter shown in FIG. 2 when it discharges; and

FIGS. 9A-9F shows various modes of the operation of the bi-directional power converter shown in FIG. 2 when it discharges.

### DETAILED DESCRIPTION OF PREFERRED EMBODIMENT

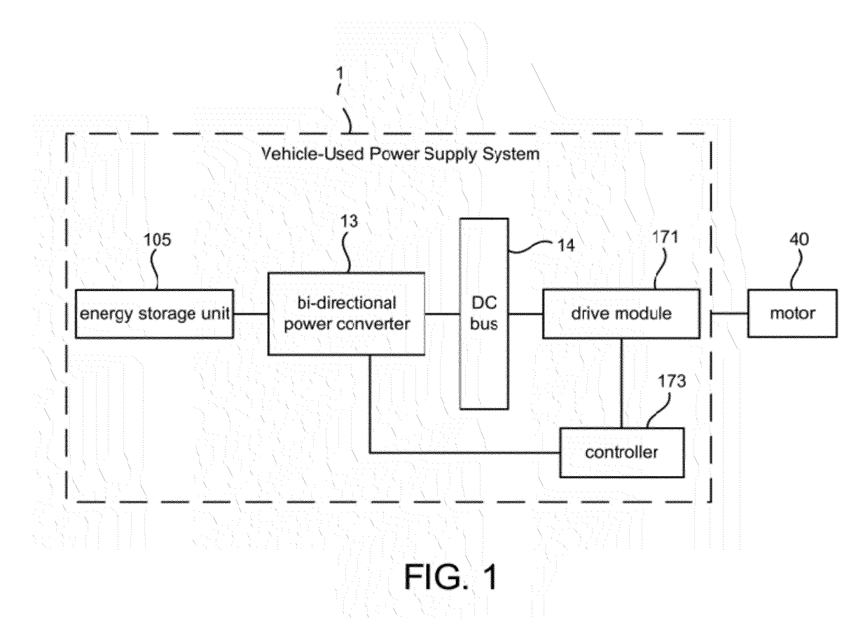

Referring to FIG. 1, there is shown a power supply system 1 for use in a vehicle according to the preferred embodiment of the present invention. The power supply system 1 includes an energy storage unit 105, a bi-directional power converter 13, a direct current (hereinafter referred to as “DC”) bus 14, a drive module 171 and a controller 173. The interconnection of the elements will be described later.

A first end of the bi-directional power converter 13 is electrically connected to the energy storage unit 105. A second end of the bi-directional power converter 13 is electrically connected to an input terminal of the DC bus 14.

An output terminal of the DC bus 14 is electrically connected to a first end of the drive module 171. The controller 173 is electrically connected to both of the drive module 171 and the bi-directional power converter 13.

The power supply system 1 is used to drive a motor 40 in the preferred embodiment. The motor 40 is electrically connected to a second end of the drive module 171.

The energy storage unit 105 can be a super capacitor module or a rechargeable secondary battery module or a combination thereof. The bi-directional power converter 13 can be a high excitation current double-winding transformer with a high air gap. The bi-directional power converter 13 can be used to boost the voltage of the electricity provided by the energy storage unit 105 to a DC bus voltage and conduct the electricity to the input terminal of the DC bus 14. The bi-directional power converter 13 can be used to reduce the voltage of electricity from the DC bus 14 and recharge the energy storage unit 105 with the electricity. The electricity from the DC bus 14 can be a DC voltage or a DC current in the preferred embodiment.

The motor 40 can be a DC brushless motor. When the motor 40 is braked, the bi-directional power converter 13 recycles energy from the motor 40. The controller 173 provides a first control signal based on the operative state of the motor 40. The first control signal is sent to the bi-directional power converter 13 to control the on and off of a power transistor of the bi-directional power converter 13 to switch the bi-directional power converter 13 between a boost mode and a reduction mode. When the motor 40 is in an actuated mode, the first control signal is a boost signal, and the bi-directional power converter 13 is in the boost mode to boost the voltage of the electricity from the energy storage unit 105 to the DC bus voltage and conduct the electricity to the DC bus 14. When the motor 40 is in a braked mode, the first control signal is a reduction signal, and the bi-directional power converter 13 is in the reduction mode to reduce the DC bus voltage of the electricity from the DC bus 14 and charge the energy storage unit 105 with the electricity.

The controller 173 sends a second control signal to the drive module 171 based on the operation of the motor 40 and the output of the electricity from the energy storage unit 105. The drive module 171 controls the rotational speed of the motor 40 based on the second control signal. Thus, the rotational speed is controlled to be constant.

The recharge and discharge of the power supply system 1 will be described below.

When the motor 40 is in the actuated mode, the controller 173 provides the first and second control signals based on a rotational speed command from the vehicle and a rotational speed feedback signal. Now, the first control signal is a boost signal, and the bi-directional power converter 13 is in the boost mode to boost the voltage of the electricity from the energy storage unit 105 to the DC bus voltage. The DC bus voltage is used as an operative voltage for the drive module 171. The drive module 171 sends a drive signal to the motor 40 to adjust the rotational speed of the motor 40 based on the second control signal.

When the motor 40 is in the braked mode, the bi-directional power converter 13 recycles energy from the motor 40 through the controller 173 and the drive module 171, and recharges the energy storage unit 105.

For example, the controller 173 provides the first and second control signals based on a brake command signal from the vehicle and the rotational speed feedback signal from the motor 40. Now, the first control signal is a reduction signal based on which the bi-directional power converter 13 is in the reduction mode and the drive module 171 brakes the motor 40 based on the second control signal.

The drive module 171 rectifies a counter electromotive force generated by the braking 40 of the motor to a DC bus voltage. The bi-directional power converter 13 reduces the DC bus voltage before it recharges the energy storage unit 105.

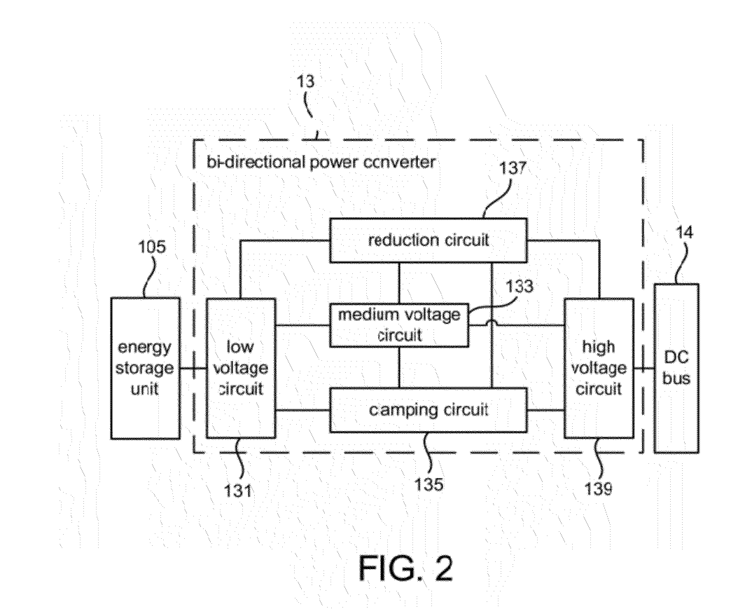

Referring to FIG. 2, the bi-directional power converter 13 is shown in detail. The bi-directional power converter 13 includes a low voltage circuit 131, a medium voltage circuit 133, a clamping circuit 135, a reduction circuit 137 and a high voltage circuit 139. The low voltage circuit 131 is electrically connected to the energy storage unit 105. The high voltage circuit 139 is electrically connected to the DC bus 14.

The low voltage circuit 131 is electrically connected to the medium voltage circuit 133, the clamping circuit 135 and the reduction circuit 137 in the preferred embodiment. The medium voltage circuit 133 is electrically connected to the clamping circuit 135, the reduction circuit 137 and the high voltage circuit 139. The clamping circuit 135 is electrically connected to the reduction circuit 137 and the high voltage circuit 139. The high voltage circuit 139 is electrically connected to the reduction circuit 137.

The bi-directional power converter 13 increases the ratio of the entire boost through the medium voltage circuit 133. The bi-directional power converter 13 protects the low voltage circuit 131 through the clamping circuit 135. The bi-directional power converter 13 provides a discharge loop for the medium voltage circuit 133 and the clamping circuit 135 through the reduction circuit 137. The high voltage circuit 139 builds a path for bi-directional transmission of energy between itself and the low voltage circuit 131 by using switches.

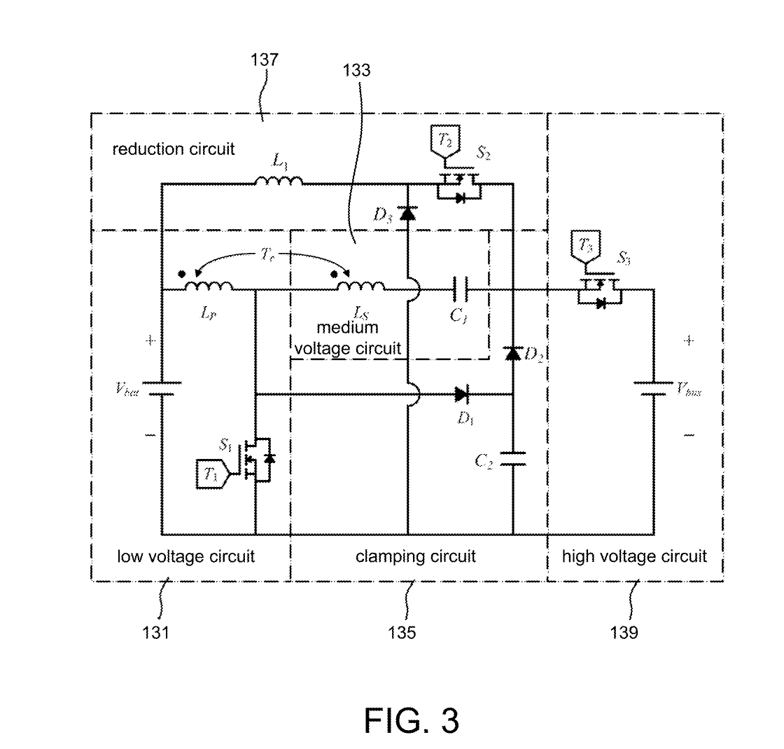

Referring to FIG. 3, there is shown a circuit diagram of the bi-directional power converter 13. Each of the energy storage unit 105 and the DC bus 14 is equivalent to a constant voltage supply. The energy storage unit 105 is represented by battery voltage V_{bat} while the DC bus 14 is represented by DC bus voltage V_{bus}. The low voltage circuit 131 includes a first switch S₁ and a first winding Lₚ. The medium voltage circuit 133 includes a second winding Lₛ and a first capacitor C. The clamping circuit 135 includes a diode D₁, a second diode D₂ and a second capacitor C₂. The reduction circuit 137 includes a third diode D₃, an inductor L₁ and a second switch S₂. The high voltage circuit 139 includes a third switch S₃.

A first end of the first winding Lₚ is electrically connected to a first end of the battery voltage V_{bat}. A first end of the first switch S₁ is electrically connected to a second end of the first winding Lₚ. A second end of the first switch S₁ is electrically connected to a second end of the battery voltage V_{bat}, thus forming a loop. A first end of the second winding Lₛ is electrically connected to the second end of the first winding Lₚ, thus forming a coupling inductance Tᵣ. The first winding Lₚ is used as the first winding of the coupling inductance Tᵣ while the second winding Lₛ is used as the second winding of the coupling inductance Tᵣ.

A first end of the first capacitor C₁ is electrically connected to a second end of the second winding Lₛ. A first end of the first diode D₁ is electrically connected to the first end of the switch S₁. A first end of the second diode D₂ is electrically connected to a second end of the first diode D₁. A second end of the first capacitor C₁ is electrically connected to a second end of the second diode D₂. A first end of the second capacitor C₂ is electrically connected to the first end of the second diode D₂. A second end of the second capacitor C₂ is electrically connected to the bus voltage V_{bus} and the second end of the first switch S₁.

A first end of the third diode D₃ is electrically connected to the second end of the first switch S₁. A first end of the inductor L₁ is electrically connected to the first end of the first winding Lₚ. A second end of the inductor L₁ is electrically connected to a second end of the third diode D₃. A first end of the second switch S₂ is electrically connected to the second end of the inductor L₁. A second end of the second switch S₂ is electrically connected to a second end of the second diode D₂. A first end of the third switch S₃ is electrically connected to a second end of the first capacitor C₁. A second end of the third switch S₃ is electrically connected to the bus voltage V_{bus}.

By turning on or off the first switch S₁, the low voltage circuit 131 stores energy through the first winding Lₚ or releases energy to the energy storage unit 105. Through the first capacitor C₁, the medium voltage circuit 133 increases the boost ratio or bears partial voltage in the reduction. The clamping circuit 135 uses the second capacitor C₂ to absorb the leak inductance energy of the coupling inductance Tᵣ to protect the first switch S₁ and release the absorbed energy to the reduction circuit 137 to recharge the energy storage unit 105. The reduction circuit 137 is used to provide a discharge loop for the medium voltage circuit 133 and the clamping circuit 135. The high voltage circuit 139 uses the third switch S₃ to provide an excitation path for the coupling inductance Tᵣ.

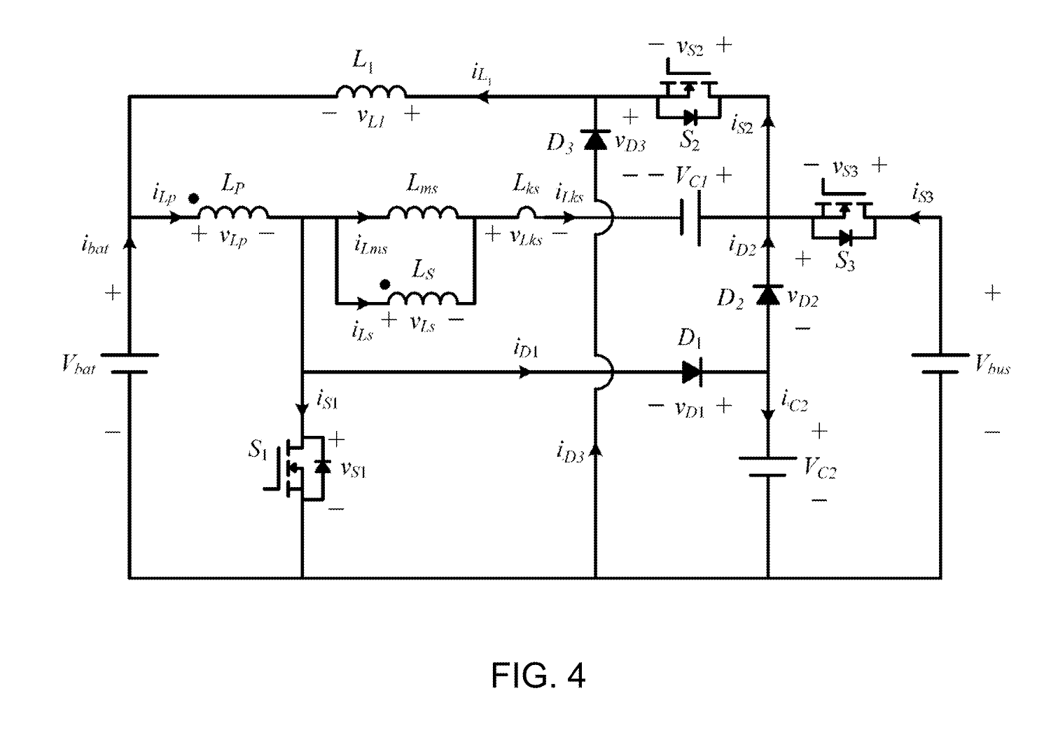

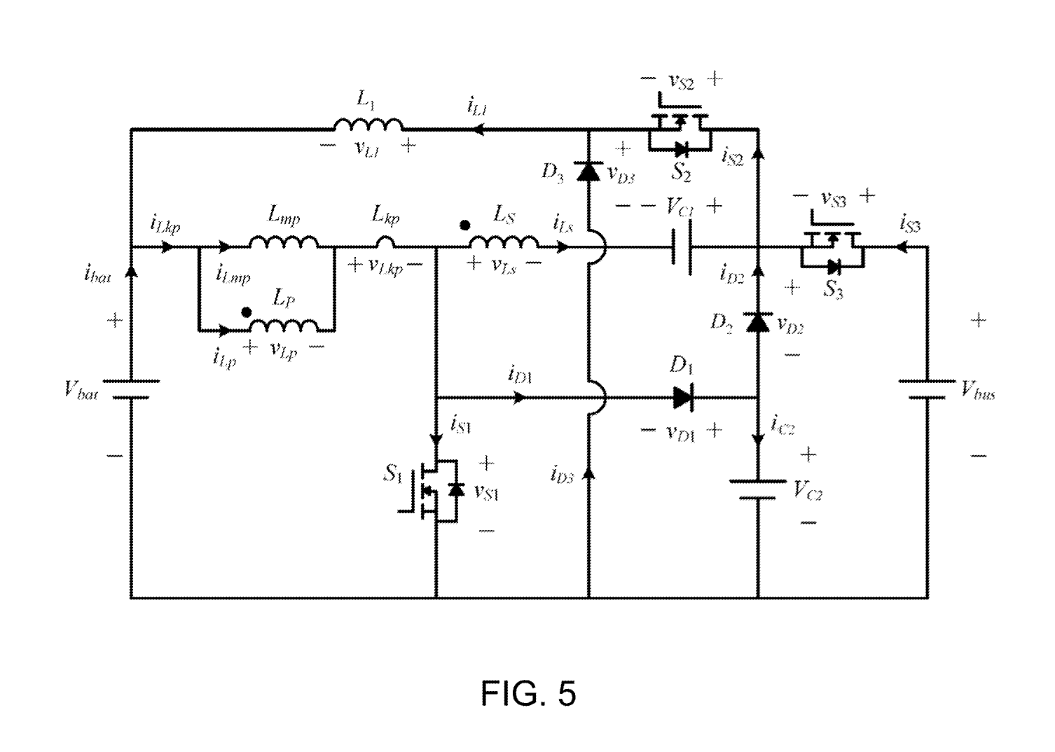

FIG. 4 shows the bi-directional power converter 13 when it is recharged. FIG. 5 shows the bi-directional power converter 13 when it discharges. To simplify the analysis of the circuit, ignored is the reduction of the voltage in all of the switches S₁, S₂ and S₃ and diodes D₁, D₂ and D₃ when they are on, and the capacitance of each of the first capacitor C₁ and the second capacitor C₂ is very high and can be assumed to be equivalent to constant voltage power supplies V_{C1} and V_{C2}. The defined directions of the voltage and current are also shown in FIGS. 4 and 5.

Referring to FIG. 4, when the power supply system 1 is in the recharge state, the bi-directional power converter 13 is in the reduction mode, and the coupling inductor Tᵣ is equivalent to the first winding Lₚ, the second winding Lₛ, the second excitation inductor Lₘₛ and the second leak inductor Lₖₛ. The turn ratio of the second winding Lₛ over the first winding Lₚ is N=N₂/N₁. The voltage in the first winding Lₚ is V_{Lp}. The voltage in the second winding Lₛ is V_{Ls}. The relation between the voltages is governed by equation (1) as follows:

$$\frac{{v}_{Ls}}{{v}_{Lp}} = N \qquad ( 1 )$$

The coupling coefficient k of the coupling inductor Tᵣ is regulated by equation (2) as follows:

$$k = \frac{{L}_{ms}}{{L}_{ks} + {L}_{ms}} \qquad ( 2 )$$

Referring to FIG. 5, when the power supply system 1 is in the discharge state, the bi-directional power converter 13 is in the boost mode, and the coupling inductor Tᵣ is equivalent to the first winding Lₚ, the second winding Lₛ, the first excitation inductor Lₘₚ and the first leak inductor Lₖₚ. The coupling coefficient k of the coupling inductor Tᵣ is regulated by equation (3) as follows:

$$k = \frac{{L}_{mp}}{{L}_{kp} + {L}_{mp}} \qquad ( 3 )$$

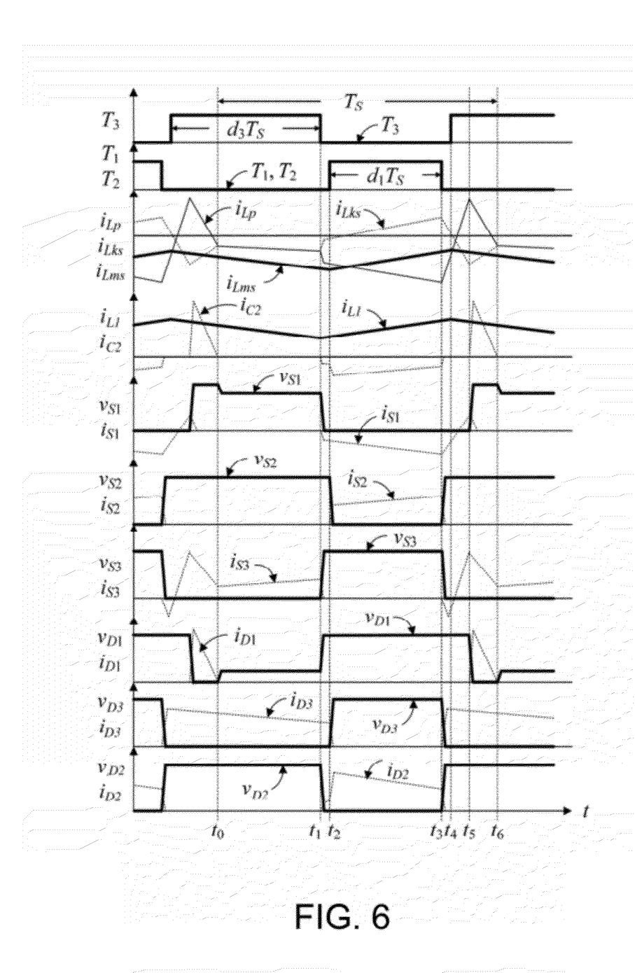

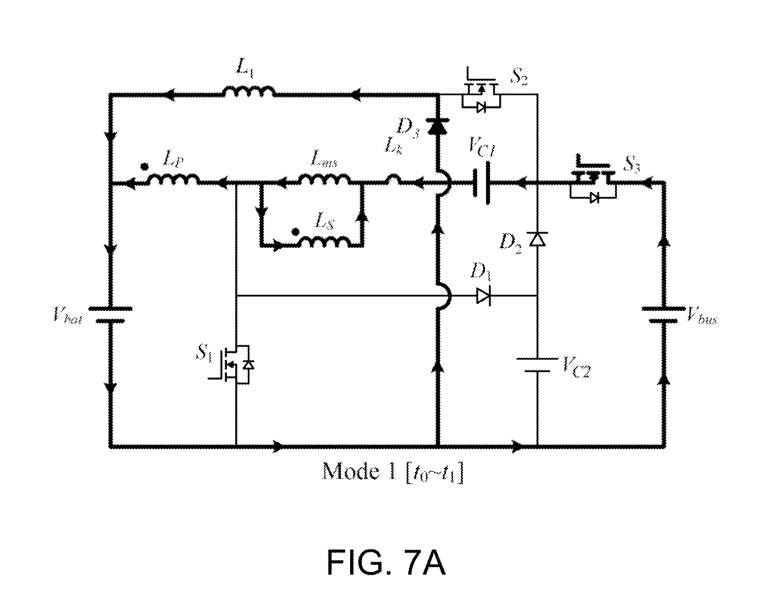

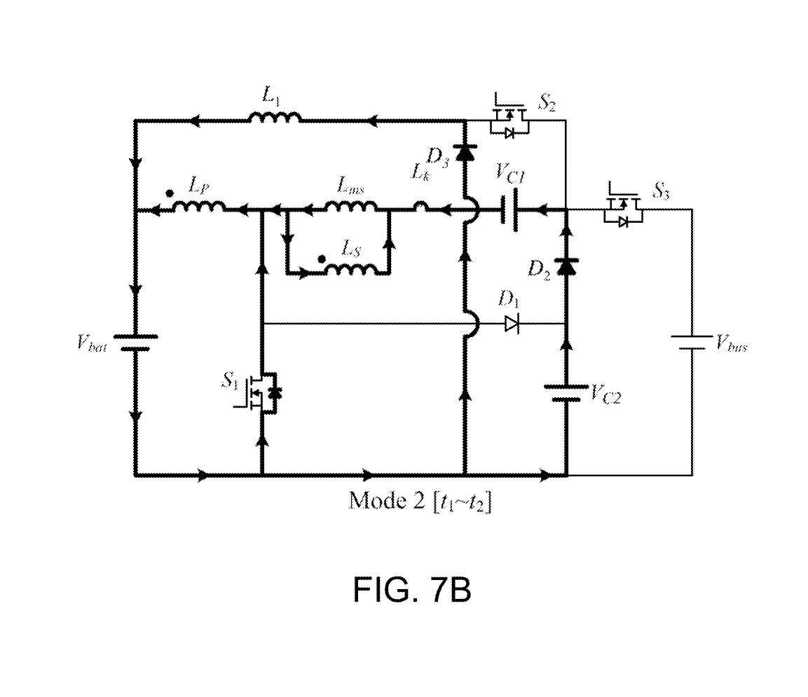

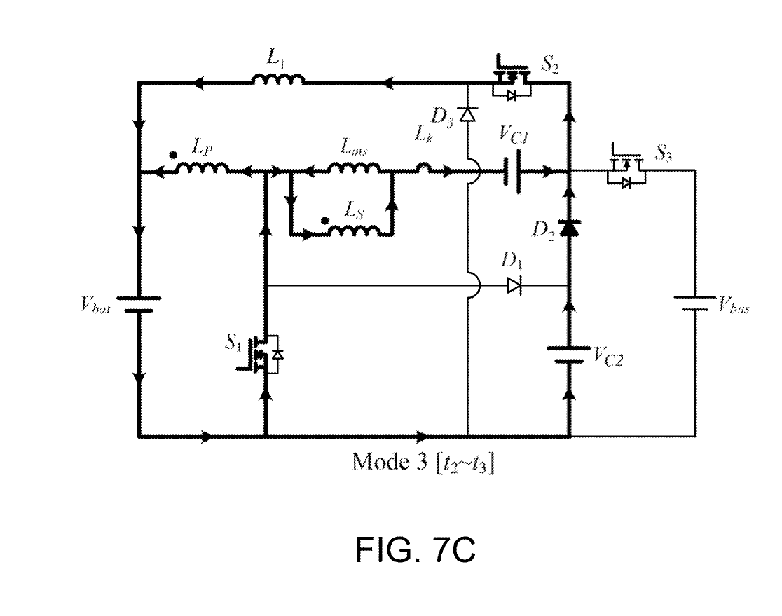

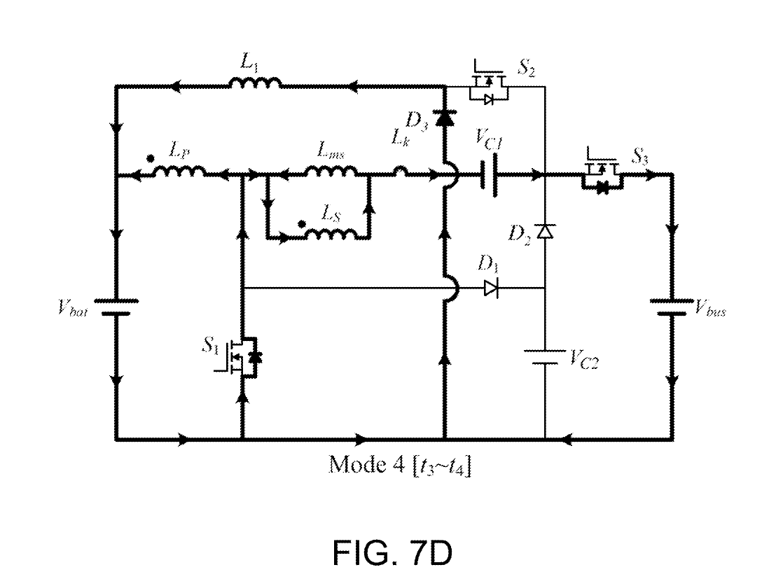

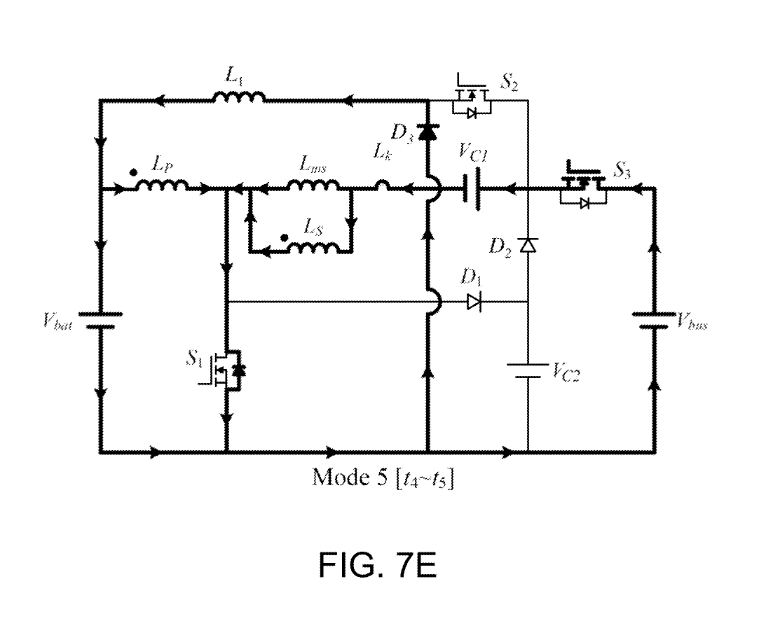

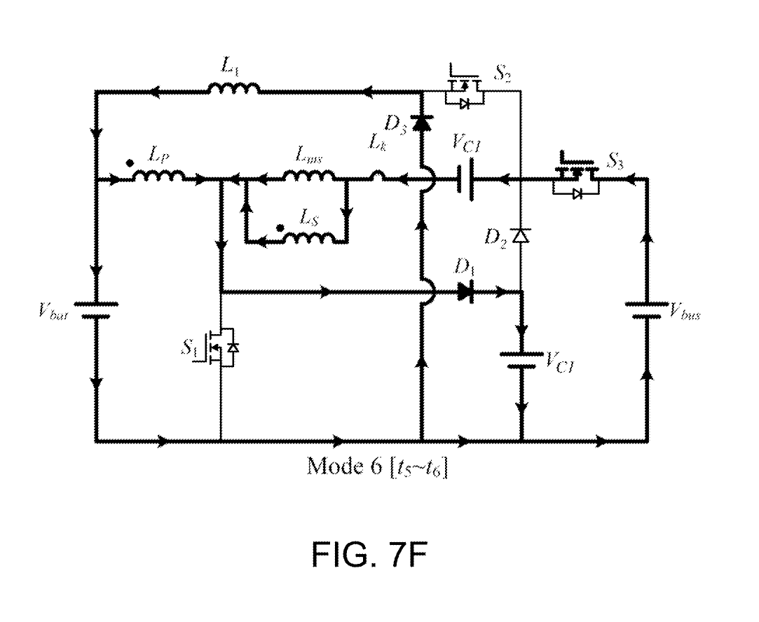

FIG. 6 shows the voltage and current versus time of the bi-directional power converter 13 when it is recharged. FIGS. 7A-7F shows various modes of the operation of the bi-directional power converter shown in FIG. 2 when it is recharged. The first drive signal T₁ of the first switch S₁ is identical to the second drive signal T₂ of the second switch S₂. The first drive signal T₁ and the second drive signal T₂ are complementary to the third drive signal T₃ of the third switch S₃. The duty period d₁ of the first switch S₁ and the second switch S₂ is defined to be d₁, the duty period d₃ of the third switch S₃, and the switch period of the bi-directional power converter 13 is defined to be Tₛ.

Mode 1 [t₀˜t₁]

When the time t=t₀, the third switch S₃ has been turned on for a period of time. The current travels to the first capacitor C₁ and the second winding Lₛ through the bus voltage V_{bus}. Finally, the current travels to the energy storage unit 105 through the first winding Lₚ. In this mode, the bus voltage V_{bus} can be regulated by equation (4) as follows:

V_{bus}=V_{C1}−v_{Lks}−v_{Ls}−v_{Lp}+V_{bat} (4)

wherein the voltage across the first winding Lₚ and the voltage across the second leak inductor Lₖₛ can respectively be referred to as v_{Lp}=(1/N)v_{Ls} and v_{Lks}=v_{Ls}(1−k)/k, and equation (4) can be rewritten to be equation (5) as follows:

$${V}_{bus} = {V}_{C 1} + {V}_{bat} - \frac{{v}_{Ls} ( k + N )}{kN} \qquad ( 5 )$$

wherein the voltage across the second excitation inductor Lₘₛ is identical to the voltage v_{Ls} across the second winding Lₛ, and equation (6) can be derived from equation (5) as follows:

$${v}_{Ls} = \frac{kN ( {V}_{bat} - {V}_{C 1} - {V}_{bus} )}{k + N} \qquad ( 6 )$$

In this mode, the bus voltage v_{bus} excites the second excitation inductor Lₘₛ, and recharges the first capacitor C₁ and the energy storage unit 105. The second excitation inductor current i_{Lms} rectilinearly decreases from a negative value. The relation between the currents is regulated by equation (7) as follows:

i_{Lks}=i_{Lp}=Ni_{Ls}=i_{Lms}+i_{Ls} (7)

Moreover, the current i_{L1} that travels through the inductor L₁ recharges the energy storage unit 105 through a loop provided by the third diode D₃ when it is on. Hence, the voltage v_{L1} across the capacitor L₁ is −V_{bat}, and the current that travels through the energy storage unit 105 is i_{Lp}+i_{L1}. Furthermore, the first switch Sᵢ is off, and the voltage V_{S1} across the first switch S₁ is V_{bat}−V_{Lp}.

Mode 2 [t₁˜t₂]

When the time t=t₁, the third switch S₃ is off. This interval is a dead zone interval after the third switch S₃ is turned off and before the first switch S₁ and the second switch S₂ are turned on. Because there is still a need for energy to be released from the second leak inductor Lₖₛ, the current i_{Lks} that travels through the second leak inductor Lₖₛ cannot be changed spontaneously so that the second diode D₂ is turned on naturally and that the current i_{Lks} that travels through the second leak capacitor Lₖₛ continues to travel through the second diode D₂ and the second capacitor C₂, but its value decreases progressively to release electricity from the second leak capacitor Lₖₛ.

The voltage across the third switch S₃ is V_{bus}−V_{C2} when it is on. The capacitance of the second excitation inductor Lₘₛ is much higher than that of the second leak capacitor Lₖₛ. Hence, the second excitation inductor current i_{Lms} can be assumed to be constant, and the slope of the decreasing thereof is much smaller than that of the second winding leak inductance current i_{Lks}. Hence, the parasitic diode of the first switch S₁ is turned on naturally to receive the first winding current i_{Lp} and the second winding current i_{Lks}. That current i_{L1} that travels through the inductor L₁ recharges the energy storage unit 105 through a loop provided by the third diode D₃ when it is on.

Mode 3 [t₂˜t₃]

When the time t=t₂, the first switch S₁ and the second switch S₂ are turned on. The parasitic diode of the first switch S₁ has been turned on since the previous mode. In this mode, direct trigger begins, and synchronous rectification is used to reduce a high loss of electricity that travels through the diodes. The second excitation inductor current i_{Lms} works in the form of a fly-back power converter, releases energy through the second winding Lₛ in a magnetically coupling manner, and induces the first winding current i_{Lp} that travels through the switch S₁ and recharges the energy storage unit 105.

After the second switch S₂ is turned on, the second capacitor voltage V_{C2} recharges the inductor L₁, and recharges the energy storage unit 105. The voltage v_{L1} across the capacitor L₁ is V_{C2}−V_{bat}. Moreover, in this mode, the energy stored in the first capacitor C₁ and the energy stored in the second capacitor C₂ recharge the inductor L₁ and the energy storage unit 105.

In this mode, the battery voltage V_{bat} can be regulated by equation (8) as follows:

V_{bat}=v_{Lp}+v_{Ls}+v_{Lks}−V_{c1}+V_{c2} (8)

The voltage across the second excitation inductor Lₘₛ is identical to the voltage v_{Ls} across the second winding Lₛ. The voltage v_{Ls} across the second winding Lₛ can be regulated by equation (9) derived from equation (8) as follows:

$${v}_{Ls} = \frac{kN ( {V}_{bat} + {V}_{C 1} - {V}_{C 2} )}{k + N} \qquad ( 9 )$$

Now, the voltage across the first winding Lₚ is identical to the battery voltage V_{bat}. Hence, equation (9) can be rewritten as equation (10) as follows:

$${V}_{bat} = \frac{k ( {V}_{bat} + {V}_{C 1} - {V}_{C 2} )}{k + N} \qquad ( 10 )$$

Mode 4 [t₃˜t₄]

When t=t₃, the first switch S₁ and the second switch S₂ are turned off. This interval is a dead zone interval after the first switch S₁ and the second switch S₂ are turned off and before the third switch S₃ is turned on. In this interval, the inductor L₁ continues to be on, and the third diode D₃ is turned on naturally. Similarly, the second leak inductor current i_{Lks} continues. Hence, the parasitic diode of the third switch S₃ is turned on naturally to receive the second leak inductor current i_{Lks} that continues to travel to the DC bus 14 and the parasitic diode of the third switch S₃.

Because the bus voltage V_{bus} is much higher than the battery voltage V_{bat}, the polarity of the voltage across the coupling inductor Tᵣ is reversed spontaneously. The slopes of first winding current i_{Lp} and the second leak inductor current i_{Lks} increase in an opposite direction. The parasitic diode of the first switch S₁ is turned on naturally to receive the sum of the current that travels through the first winding Lₚ and the current that travels through the second winding Lₛ.

Mode 5 [t₄˜t₅]

When t=t₄, the parasitic diode of the third switch S₃ is turned on, the voltage v_{S3} across the third switch S₃ is zero. Now, the third switch S₃ is on, and its wave form exhibits the effects of zero-voltage switch.

Because the previous mode where the currents continue to travel through the elements is coming to an end and the third switch S₃ provides an excitation path for the coupling inductor Tᵣ, the second excitation inductor Lₘₛ receives excitation again, and the current i_{Lp} that travels through the first winding is decreasing. Because of the excitation of the second excitation inductor Lₘₛ, the non-polar voltage of the first winding Lₚ is positive, the parasitic diode of the first switch S₁ is turned off, and the first winding current i_{Lp} begins to recharge the parasitic capacitor of the first switch S₁. Because the capacitance of the parasitic capacitor of the first switch S₁ is higher than that of ordinary high voltage switches and residual charge must be removed from the parasitic diode, a large recharging current is needed when the voltage boosts.

Mode 6 [t₅˜t₆]

When t=t₅, the voltage v_{S1} across the first switch is higher than the second capacitor voltage V_{C2}. Now, the first diode D₁ is on to conduct the electricity to the second capacitor C₂ from the parasitic capacitor of the first switch S₁. Because the capacitance of the second capacitor C₂ is high, there is almost no ripple in the second capacitor voltage V_{C2}. In this mode, based on the voltage loop, the voltage across the second excitation inductor Lₘₛ can be represented by equation (9), and the second capacitor voltage V_{C2} can be represented by equation (11) as follows:

$${V}_{C 2} = \frac{k ( {V}_{bus} - {V}_{bat} - {V}_{C 1} )}{k + N} + {V}_{bat} \qquad ( 11 )$$

When energy is released from the second leak capacitor Lₖₛ to the coupling inductor Tᵣ where the current is balanced, the first winding current i_{Lp} can be represented by equation (12) as follows:

i_{Lp}=i_{Lks}=i_{Lms}−Ni_{Lp}=i_{Lms}+i_{Ls} (12)

Now, the first diode D₁ is off, and a switching cycle is completed. Then, the operation is returned to mode 1.

In the preferred embodiment, the winding coupling effects are good because the coupling inductor Tᵣ is wounded in a sandwich-like manner. In addition, the leak inductor energy of the coupling capacitor Tᵣ is little in comparison with the iron powder core, and imposes few effects on the system as long as the voltage clamping is good to fully absorb the leak inductor energy. To simplify the equation for the convenience of the analysis, the coupling coefficient k is defined to be 1. Moreover, the dead zone interval is assumed to be very short. Therefore, the duty period d₁ of the firs switch S₁ and the duty period d₃ of the third switch S₃ are close to 1, i.e., d₁+d₃=1. According to volt-second balance, based on the volt-second balance of the second excitation inductor Lₘₛ and equations (6) and (9), equation (13) can be derived as follows:

(V_{bat}+V_{C1}−V_{bus})d₃+(V_{bat}+V_{C1}−V_{C2})(1−d₃)=0 (13)

Similarly, based on the volt-second balance of the capacitor L₁, equation (14) can be derived as follows:

$${V}_{C 2} = \frac{{V}_{bat}}{1 - {d}_{3}} \qquad ( 14 )$$

Based on equations (10), (13) and (14), the reduction ratio G_{V1} can be represented by equation (15) as follows:

$${G}_{V 1} = \frac{{V}_{bat}}{{V}_{bus}} = \frac{{( 1 - {d}_{3} )}^{2}}{1 + {d}_{3} N} \qquad ( 15 )$$

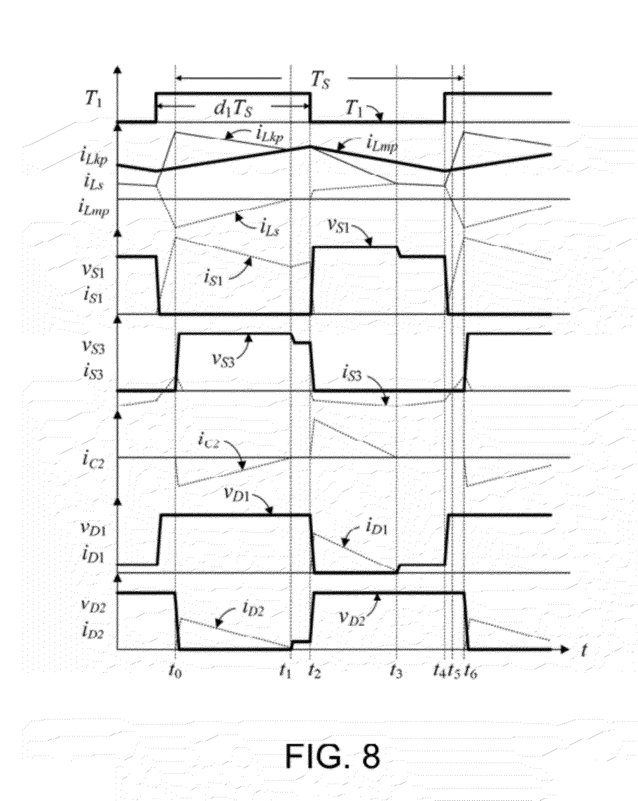

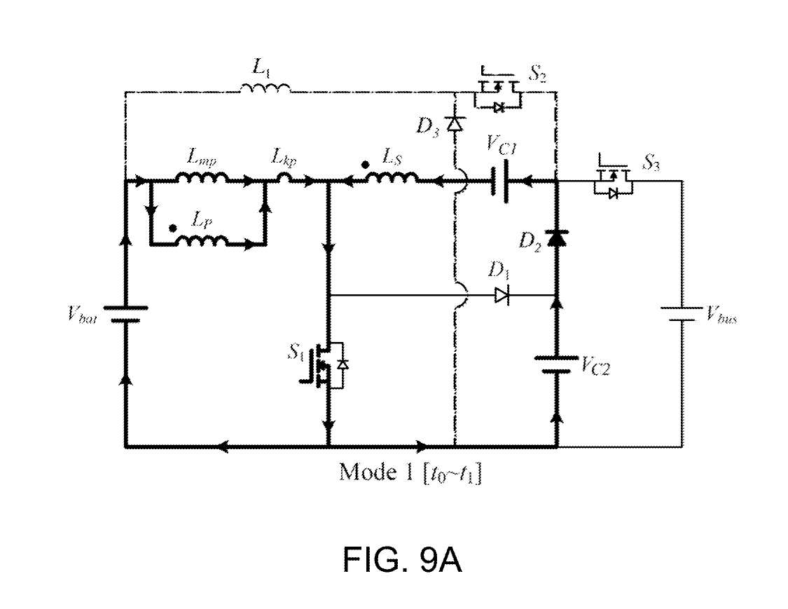

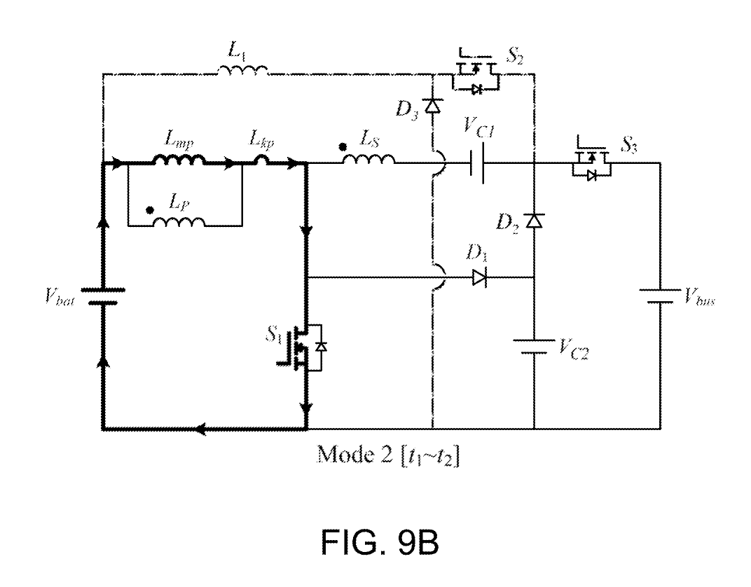

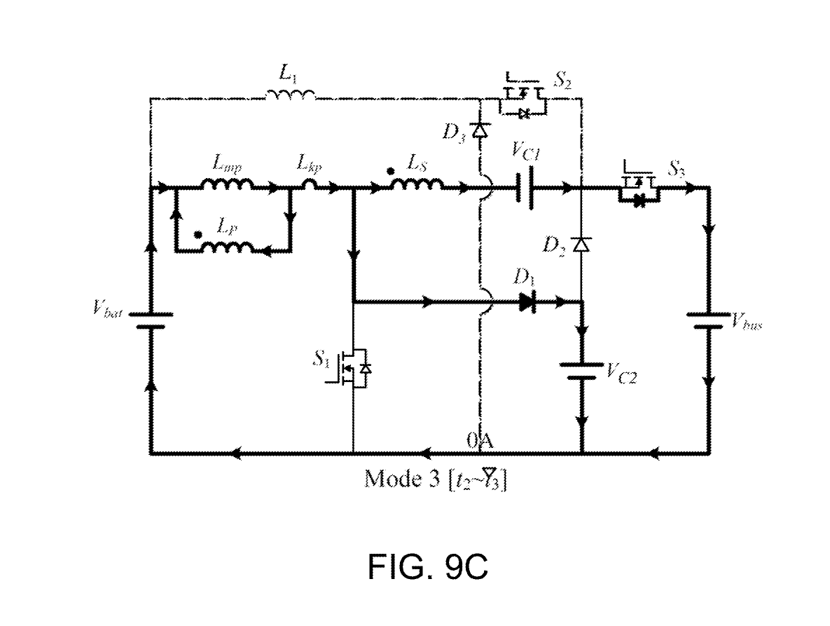

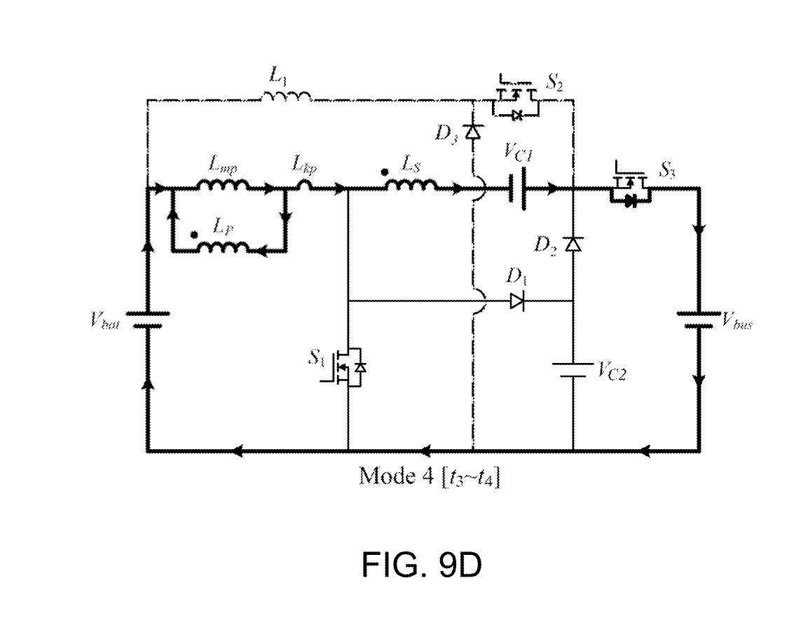

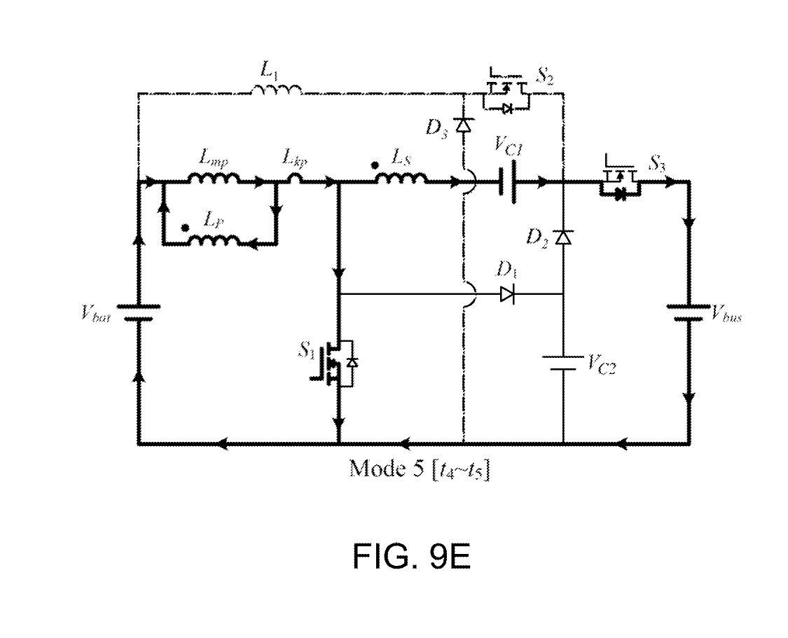

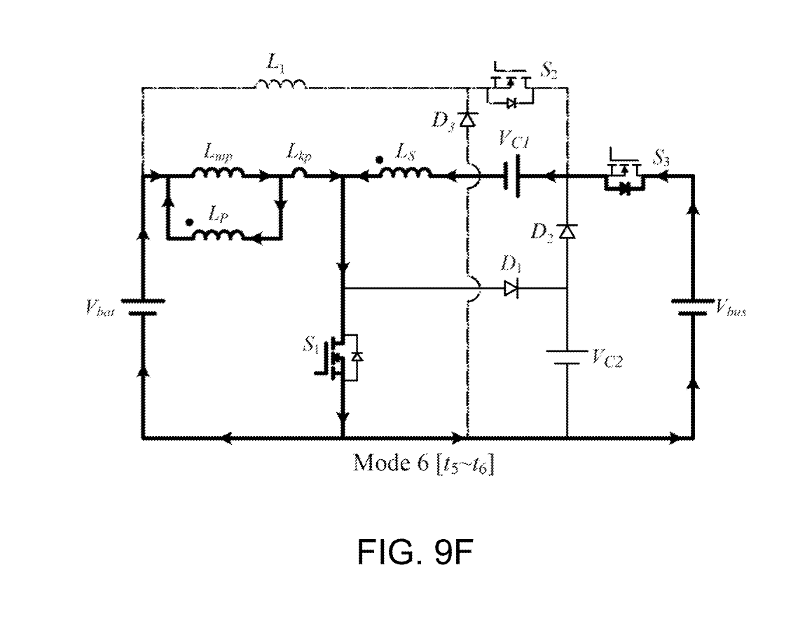

FIG. 8 is a chart of voltages and currents versus time of the bi-directional power converter 13 when it discharges. FIGS. 9A-9F shows various modes of the operation of the bi-directional power converter 13 when it discharges.

Referring to FIG. 8, the duty period of the first switch S₁ is defined to be d₁. The switch period Tₛ of the bi-directional power converter 13 is defined to be Tₛ. When the bi-directional power converter 13 is in the boost mode, only the first switch S₁ is turned on while the capacitor L₁, the third diode D₃ and the second switch S₃ included in the reduction circuit 137 do not have to work. The reduction circuit 137 is shown by dashed lines in FIGS. 9A-9F.

Mode 1 [t₀˜t₁]

When t=t₀, the first switch S₁ has been turned on for a period of time. Because the second capacitor voltage V_{C2} releases energy, the battery voltage V_{bat} recharges the first excitation inductor Lₘₚ by excitation, and the coupling inductor Tᵣ releases energy from the second capacitor V_{C2} to the first capacitor V_{C1} by magnetic induction. The current in the first switch S₁ can be represented by i_{S1}=i_{Lkp}−i_{Ls}, wherein the second winding current i_{Ls} is negative, and its amplitude decreases as the second capacitor voltage V_{C2} releases energy. In mode 1, the circuit loop can be represented by equation (16) as follows:

V_{bat}=v_{Lp}+v_{Lkp}+v_{Ls}−V_{C1}+V_{C2} (16)

wherein, the voltage across the second winding Lₛ and the voltage across the first leak inductor Lₖₚ can respectively be represented by v_{Ls}=Nv_{Lp} and v_{Lkp}=v_{Lp}(1−k)/k, and equation (16) can be rewritten to be equation (17) as follows:

$${V}_{bat} = {V}_{C 2} - {V}_{C 1} + {v}_{Lp} + \frac{{v}_{Lp} ( 1 - k )}{k} + {Nv}_{Lp} \qquad ( 17 )$$

The voltage across the first excitation inductor Lₘₚ is identical to the voltage v_{Lp} across the first winding Lₚ. Based on equation (17), the voltage v_{Lp} across the first winding Lₚ can be represented by equation (18) as follows:

$${v}_{Lp} = \frac{k ( {V}_{bat} + {V}_{C 1} - {V}_{C 2} )}{1 + Nk} \qquad ( 18 )$$

Moreover, the sum of the voltage across the first excitation inductor Lₘₚ and the voltage v_{Lkp} across the first leak inductor Lₖₚ is identical to the battery voltage V_{bat}. Hence, in consideration of the voltage loop of the second winding Lₛ, the relation between the second capacitor voltage V_{C2} and the first capacitor voltage V_{C1} can be represented by equation (19) as follows:

V_{C1}=v_{Ls}+V_{C2}=NkV_{bat}+V_{C2} (19)

Mode 2 [t₁˜t₂]

When t=t₁, the first switch S₁ has been turned on for a period of time, the release of energy from the second capacitor voltage V_{C2} has been completed, and the current i_{Ls} that flows through the second winding Lₛ has decreased to zero. Now, the second diode D₂ is reverse-biased. In this mode, the battery voltage V_{bat} of the low voltage circuit 131 imposes excitation on the first excitation inductor Lₘₚ and the first leak inductor Lₖₚ.

Mode 3 [t₂˜t₃]

When t=t₂, the first switch S₁ is turned off. The first leak inductor current i_{Lkp} must continue. Hence, the first diode D₁ is turned on naturally to receive the difference between the first leak inductor current i_{Lkp} and the second winding current i_{Ls}. The energy in the first leak inductor Lₖₚ recharges the second capacitor voltage V_{C2}, and the relation between the currents can be represented by equations (20a) and (20b) as follows:

i_{Lkp}=i_{Lmp}+i_{Lp}=i_{Lmp}−i_{Ls}/N (20a)

i_{D1}=i_{Lkp}−i_{Ls}=i_{Lmp}−i_{Ls}(1+1/N) (20b)

When the first winding Lₚ induces the second winding current i_{Ls}, the parasitic diode of the third switch S₃ is turned on naturally to transmit energy from the battery voltage V_{bat}, the coupling inductor Tᵣ and the first capacitor C₁ to the DC bus 14. In this mode, the relation between the voltages can be represented by equation (21) as follows:

V_{bat}=V_{C1}−v_{Lkp}−v_{Ls}−v_{Lp}+V_{bat} (21)

The voltage across the first excitation inductor Lₘₚ is identical to the voltage V_{Lp} across the first winding Lₚ. From equation (21), equation (22) can be derived as follows:

$${v}_{Lp} = \frac{k ( {V}_{bat} + {V}_{C 1} - {V}_{bus} )}{1 + kN} \qquad ( 22 )$$

When the first switch S₁ is turned off, and its voltage v_{S1} is identical to the second capacitor voltage V_{C2}, based on the voltage loop equation, the second capacitor voltage V_{C2} can be represented by equation (23) as follows:

$${V}_{C 2} = \frac{( {V}_{bus} - {V}_{bat} - {V}_{C 1} )}{1 + Nk} + {V}_{bat} \qquad ( 23 )$$

Mode 4 [t₃˜t₄]

When t=t₃, the first switch S₁ has been turned on for a period of time, and the release of energy from the first leak capacitor Lₖₚ to the second capacitor voltage V_{C2} has been completed, and the first diode current i_{D1} has decreased to zero. Now, the first diode D₁ is reverse-biased. In this mode, the battery voltage V_{bat} of the low voltage circuit 131 is connected to the coupling inductor Tᵣ and the first capacitor C₁ in series, and all of them release energy to the DC bus 14.

Mode 5 [t₄˜t₅]

When t=t₄, the first switch S₁ is turned. When the parasitic diode of the third switch S₃ is turned on, the voltage across the first leak inductor Lₖₚ of the first winding Lₚ is reversed spontaneously, and the current i_{Ls} traveling to the DC bus 14 decreases.

Mode 6 [t₅˜t₆]

When t=t₅, the first switch S₁ has been turned on for a period of time, the current i_{Ls} that travels to the DC bus 14 has decreased to zero. The second winding current i_{Ls} is negative. The parasitic diode of the third switch S₃ is turned on in the previous mode. A large current is needed to remove any residual charge from the parasitic diode of the third switch S₃ when the third switch S₃ is turned off. Hence, a high recharging voltage is needed when the voltage v_{S3} across the switch S₃ boosts. When the third switch voltage v_{S3} boosts to V_{bus}−V_{C2}, the second diode D₂ is turned on, and a switching cycle is completed. Then, the operation is returned to mode 1.

The winding coupling effects are good because the coupling inductor Tᵣ is wounded in a sandwich-like manner. In addition, the leak inductor energy of the coupling capacitor Tᵣ is little in comparison with the iron powder core, and imposes few effects on the system as long as the voltage clamping is good to fully absorb the leak inductor energy. To simplify the equation for the convenience of the analysis, the coupling coefficient k is defined to be 1. According to volt-second balance, the voltage across the first excitation inductor Lₘₚ can be represented by equation (18) in the period d₁Tₛ when the first switch S₁ is on. In the period (1−d₁)Tₛ when the first switch S₁ is off, the first excitation inductor Lₘₚ can be represented by equation (22). Based on volt-second balance, equation (24) can be derived as follows:

(V_{bat}+V_{C1}−V_{C2})d₁+(V_{bat}+V_{C1}−V_{bus})(1−d₁)=0 (24)

Based on equations (19), (23) and (24), the boost ratio G_{V2} can be represented by equation (25) as follows:

$${G}_{V 2} = \frac{{V}_{bus}}{{V}_{bat}} = \frac{2 + N}{1 - {d}_{1}} \qquad ( 25 )$$

The boost mode and the reduction mode of the bi-directional power converter 13 when the power supply system 1 is in the recharge state and the discharge state have been described above. It should be noted that the elements included in the bi-directional power converter 13 and their interconnection are not limited to what have been described above. If the power supply system 1 is only operated in one of the modes, some of the elements can be replaced with other elements or omitted. For example, if only the recharge state is used, i.e., the bi-directional power converter 13 is only operated in the reduction mode, the first switch S₁ is only used in the synchronous rectification mode. Hence, the first switch S₁ can be replaced with a low pass loss Schottkey diode. If only the discharge state is used, i.e., the bi-directional power converter 13 is only operated in the boost mode, the reduction circuit 137 can be omitted. Moreover, the third switch S₃ is only used in the synchronous rectification mode. Hence, the third switch S₃ can be replaced with an ordinary diode.

The power supply system 1 exhibit at least two features. At first, the bi-directional power converter 13 converts the energy from the energy storage unit 105 into power for the motor 40. The bi-directional power converter 13 includes a small number of elements, and exhibits a high differential voltage ratio and high conversion efficiency. Hence, the bi-directional power converter 13 fully uses the energy to stably provide power for the vehicle without the need for a high voltage battery module. Thus, the life of the energy storage is extended.

Secondly, when the motor 40 is stopped, the bi-directional power converter 13 recycles energy from the motor 40, reduces the recycled energy, and recharges the energy storage unit 105. Thus, the speed and efficiency of the recharge of the energy storage unit 105 are increased.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A vehicle-used power supply system including:
an energy storage unit 105;
a direct current bus 14;
a bi-directional power converter 13 electrically connected to the energy storage unit 105 and the direct current bus 14, wherein the bi-directional power converter 13 includes a coupling inductor, wherein the bi-directional power converter 13 boosts electricity from the energy storage unit 105 and provides direct current bus electricity to the direct current bus 14;
a controller 173 electrically connected to a motor 40 and the bi-directional power converter 13, wherein the controller 173 provides a first control signal and a second control signal based on the operation of the motor 40 and the output of the electricity from the energy storage unit 105, wherein the first control signal controls the bi-directional power converter 13 to switch between a boost mode and a reduction mode; and
a drive module 171 electrically connected to the direct current bus, the controller and the motor, wherein the drive module 171 receives the direct current bus electricity and controls the rotational speed of the motor 40.

2. The vehicle-used power supply system according to claim 1, wherein the energy storage unit 105 includes at least one of the modules selected from the group consisting of a super capacitor module and a rechargeable secondary battery module.

3. The vehicle-used power supply system according to claim 1, wherein the first control signal is a boost signal to control the bi-directional power converter 13 in a boost mode when the motor 40 is in an actuated mode, wherein the first control signal is a reduction signal to control the bi-directional power converter 13 in a reduction mode when the motor 40 is in a braked mode.

4. The vehicle-used power supply system according to claim 3, wherein when the motor 40 is in the braked mode, the drive module 171 converts a counter electromotive force of the motor 40 to the direct current bus electricity and conducts the same to the bi-directional power converter which reduces the direct current bus electricity before it recharges the energy storage unit 105.

5. The vehicle-used power supply system according to claim 1, wherein the bi-directional power converter 13 includes:
a low voltage circuit 137 including a first switch S₁ and a first winding Lₚ, wherein a first end of the first winding Lₚ is electrically connected to a first end of the energy storage unit 105, wherein a second end of the first winding Lₚ is electrically connected to a first end of the first switch S₁, wherein a second end of the first switch S₁ is electrically connected to a second end of the energy storage unit 105;
a medium voltage circuit 133 including a second winding Lₛ and a first capacitor C₁, wherein a first end of the second winding is electrically connected to the second end of the first winding to form the coupling inductor, wherein a second end of the second winding is electrically connected to a first end of the first capacitor, wherein the medium voltage increases the boost ratio of the bi-directional power converter through the first capacitor;
a clamping circuit 135 including a second capacitor C₂, wherein a first end of the second capacitor is electrically connected to a second end of the first capacitor, wherein a second end of the second capacitor is electrically connected to the second end of the first switch, wherein the clamping circuit absorbs leak inductor energy of the coupling inductor through the second capacitor to protect the first switch and releases the leak inductor energy to the energy storage unit;
a reduction circuit 137 including a second switch S₂ and an inductor L₁, wherein a first end of the second switch is electrically connected to a first end of the inductor, wherein a second end of the second switch is electrically connected to the second end of the first capacitor, wherein a second end of the inductor is electrically connected to the first end of the first winding, wherein the reduction circuit provides a discharge loop for the medium circuit and the clamping circuit; and
a high voltage circuit 139 including a third switch S₃ electrically connected to the second end of the first capacitor, wherein the third switch provides a magnetic excitation path for the coupling inductor.

6. The vehicle-used power supply system according to claim 5, wherein the coupling inductor is a high excitation current double-winding transformer with a high air gap.

7. The vehicle-used power supply system according to claim 5, wherein the clamping further includes a first diode D₁ and a second diode D₂, wherein a first end of the first diode is electrically connected to the first end of the first switch, wherein a first end of the second diode is electrically connected to a second end of the first diode, wherein a second end of the second diode is electrically connected to the second end of the first capacitor.

8. The vehicle-used power supply system according to claim 7, wherein the reduction circuit further includes a third diode D₃, wherein a first end of the third diode is electrically connected to the second end of the first switch, wherein a second end of the third diode is electrically connected to the first end of the second switch.
